(19) United States
(12) Patent Application Publication
(10) Pub. No.: US 2021/0182438 A1
(43) Pub. Date: Jun. 17, 2021

(54) SECURING A COMPUTER PROCESSING ENVIRONMENT FROM RECEIVING UNDESIRED CONTENT

(71) Applicant: SAFE12, INC., San Jose, CA (US)

(72) Inventors: Roger T. Huitt, Soquel, CA (US); Qing Wang, Palo Alto, CA (US)

(21) Appl. No.: 16/712,886

(22) Filed: Dec. 12, 2019

(51) Int. Cl. G06F 21/84; G06F 21/32; G02B 27/01; G02B 27/00

(52) U.S. Cl. CPC G06F 21/84; G06F 21/32; G06F 2221/2141; G02B 27/0093; G02B 27/017

(57) ABSTRACT

Methods and apparatus consistent with the present disclosure may receive sensor data from sensors that sense user biometric data when the identity of a user is validated. Apparatus consistent with the present discourse may include a display that may be worn on the head of a user. Methods consistent with the present disclosure may also require that an authorized user be identified as wearing this display on their head before sensitive data is displayed on a display of the head worn display. An apparatus consistent with the present disclosure may also include multiple different sets of different computers that are separated by one or more switches. Each of these different computers may include its own processor and memory. Data received by a first computer within an apparatus may be scanned for malicious program code before that data is allowed to be provided to a second computer within the apparatus.

### BACKGROUND OF THE INVENTION

### Field of Invention

The present invention generally relates to protecting sensitive data from being accessed by unauthorized persons. More specifically the present invention is directed to validating that only authorized users can view sensitive content displayed on a display.

### Description of the Related Art

Threats to secure computer data include the prying eyes of individuals that may see data displayed on a computer screen and software that can compromise or steal computer data. The government of the United States (US) is very concerned that individuals without proper security clearances may view documents that are considered classified, secret, or top secret. Any individual who may walk into a room where sensitive documents are located or displayed on a display is a security risk. Even individuals that are not physically in a room may be a security threat. For example, secure materials may be viewed by individuals who are far from a display screen by viewing that screen using a pair of binoculars or a telescope. Secure materials may also be viewed by persons who have placed hidden cameras in a room where secure materials are viewed. While the US government does setup facilities where sensitive data may be viewed in an environment free from prying eyes, setting up such facilities in new locations is an expensive and time consuming task. What are needed are new method and apparatus that allow secure data to be viewed virtually at any time and virtually at any location in a manner that maintains the highest level of security.

Malware, computer viruses, and eavesdropping software have been used to steal sensitive information, destroy computer data, and hold computer data for ransom. Malware broadly refers to malicious software designed to infiltrate and/or damage a computer system and/or network without the an owner of a computer or computer network being aware that their data has been compromised. Another problem that affects computing devices is the dissemination of undesired advertisements and messages. Damage from such “spam” messages or malware are not limited to time lost sorting through these undesired messages, yet also can include “phishing” attacks that can steal personal information or attacks like the “I Love You” virus that spawn excessive email traffic with the intent to crash a computer network.

Generally malware can be any software program that includes code that executes without the knowledge or authorization of an owner or user of a computing device. Malware is typically distributed by parties with nefarious intent. Malware is commonly used steal or destroy computer data or to snoop or spy the actions of a user when the user operates a computer. Malware is also frequently used to damage a computer or to damage computer data. For example, malware may be used to steal personal or financial information, blackmail computer users by denying access to their own data unless or until a fee is paid, damage infected computers by damaging data stored on those infected computers, or to steal classified information.

Because of the threats posed to computing devices in general and to government security requirements, new methods and apparatus are needed to secure these computing devices from exploitation by various forms of malicious program code or by prying eyes.

### SUMMARY OF THE CLAIMED INVENTION

The presently claimed invention relates to a method, a non-transitory computer readable storage medium, or an apparatus/system that performs functions consistent with the present disclosure. A method consistent with the present disclosure may identify that a switch has been set in a first position after which a secure mode of operation may be initiated at a computing device. This secure mode of operation may control when sensitive data may be displayed on a display. Next, biometric data of a person may be received. This biometric data may be received after an eye of a person has been focused on the display. The received biometric data may be used to identify that the received biometric data matches biometric data of an authorized user. After the person has been identified as being the authorized user, the sensitive data may be displayed on the display.

When the method of the presently claimed invention is performed by a non-transitory computer readable storage medium, a processor executing instructions out of a memory may identify that a switch has been set in a first position after which a secure mode of operation may be initiated at a computing device. This secure mode of operation may control when sensitive data may be displayed on a display. Next, biometric data of a person may be received. This biometric data may be received after an eye of a person has been focused on the display. The received biometric data may be used to identify that the received biometric data matches biometric data of an authorized user. After the person has been identified as being the authorized user, the sensitive data may be displayed on the display.

An apparatus consistent with the present disclosure may include a display, a sensor that senses biometric data, a switch, a first memory, and a first processor. The processor may execute instructions out of the memory to identify that a switch has been set in a first position after which a secure mode of operation may be initiated at a computing device. The processor may then control when sensitive data is displayed on a display. The processor may then receive the biometric data of a person that is focusing an eye on the display, identify that the received biometric data matches biometric data of an authorized user, and then may control the display of the sensitive data on the display.

### BRIEF DESCRIPTION OF THE DRAWINGS

FIG. 1 illustrates a computing device that may receive information from a secure computer.

FIG. 2 illustrates a modular apparatus where a computing device may be physically connected to a unit that may be worn on the head of a person.

FIG. 3 illustrates a series of steps that may be performed when steps consistent with the present disclosure are implemented.

FIG. 4A illustrates a configuration where three different components of a system are communicatively disconnected/isolated from each other.

FIG. 4B illustrates an exemplary configuration consistent with the present disclosure.

FIG. 4C illustrates a second exemplary configuration consistent with the present disclosure.

FIG. 5 illustrates exemplary switches that may be used to connect an intelligent switch to either a secondary environment or a primary environment

FIG. 6 illustrates components that maybe included in a primary environment and in a secondary environment.

FIG. 7 illustrates an exemplary flow of actions consistent with the present disclosure that may be performed when a user wishes to access content from a remote computing device.

FIG. 8 illustrates a computing system that may be used to implement an embodiment of the present invention.

### DETAILED DESCRIPTION

The present disclosure is directed to protecting sensitive information from being viewed or acquired by persons that are not authorized to view or receive this sensitive information. The present disclosure is also directed to preventing forms of malicious software from exploiting a computer. Methods and apparatus consistent with the present disclosure may protect primary computing environments and data from being exploited by individuals that do not have security clearances. Patent application Ser. No. 16/286,017, filed Feb. 26, 2019, entitled “Securing a Computer Processing Environment from Receiving Undesired Content” is incorporated by reference into the present application.

Methods and apparatus consistent with the present disclosure may receive sensor data from sensors that sense user biometric data when the identity of a user is validated. Apparatus consistent with the present discourse may include a display that may be worn on the head of a user. Methods consistent with the present disclosure may also require that an authorized user be identified as wearing this display on their head before sensitive data is displayed on a display of the head worn display. An apparatus consistent with the present disclosure may also include multiple different sets of different computers that are separated by one or more switches. Each of these different computers may include its own processor and memory. Data received by a first computer within an apparatus may be scanned for malicious program code before that data is allowed to be provided to a second computer within the apparatus.

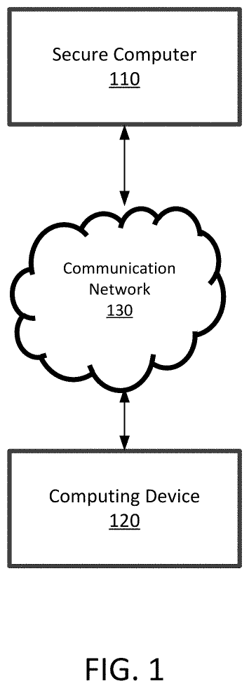

FIG. 1 illustrates a computing device that may receive information from a secure computer. FIG. 1 includes secure computer 110 and communication device 120 that may communicate with each other via communication network 130. While in certain instances, communication network 130 may use communication interfaces capable of communicating via public accessible networks such as the cloud or Internet, communication network 130 may be any communication network known in the art that may or may not communicate via a public accessible network. In certain instances, communication network 130 may be a proprietary network, as such, communication network 130 may be a satellite communication network, be a ultra-low frequency communication network, be a radio communication network, or be a network that communicates via light. As such, communications sent via communication network 130 may be transmitted using any standard or any proprietary communication technology wired or wireless. In certain instances, apparatus consistent with the present disclosure may include or be coupled to a device that receives signals via space, the atmosphere, or the water (e.g. the ocean). Ultra-low frequency communications are transmitted through the waters of the ocean to submarines that may receive these ultra-low frequency communications via a submerged antenna.

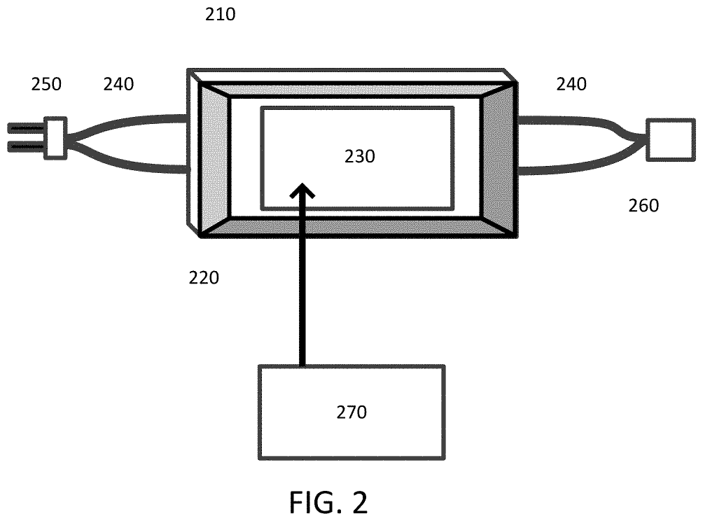

FIG. 2 illustrates a modular apparatus where a computing device may be physically connected to a unit that may be worn on the head of a person. FIG. 2 includes head mountable unit 210 and user device 270. Head unit 210 includes screen shade 220, head mounting straps 240, male fastening clip 250, female fastening clip 260, and receiving portion 230. User device 270 may be attached to head unit 210 by attaching user device 270 to receiving portion 230. User device 270 may be physically attached to head unit 210 by friction, by straps, or by magnets. When friction is used, user device 270 may be attached to receiving portion 230 of head unit 210 by press fitting user device 270 into a cavity located at receiving portion 230 of head unit 270. Once user device 270 is attached to head unit 210, a user may place the visor portion of head unit 210 around their eyes and then the user may strap head unit 210 onto their head by connecting male and female fastening clips 250 & 260 together.

Once visor 220 is placed around the eyes of the user, a processor at head unit 210 or at user device 270 may receive biometric data from one or more sensors. For example, a camera or an infrared (IR) sensor may capture images of the user's eyes and that image data may be used when a processor executes instructions that identify the identity of the user. Processors executing instructions out of a memory at user device 270 or head unit 210 may then selectively display content to the user. In certain instances, a user may not be required to strap a head mounted unit to their head, yet may be required to view a display by placing their eyes in a screen shade similar to screen shade 220 of FIG. 2 as the user holds the display screen shade around their eyes. The holding of a visor up to a person's eyes may be sufficient for a method consistent with the present disclosure to identify that the user is “wearing” the head mounted unit even though the unit is not strapped to the head of the person.

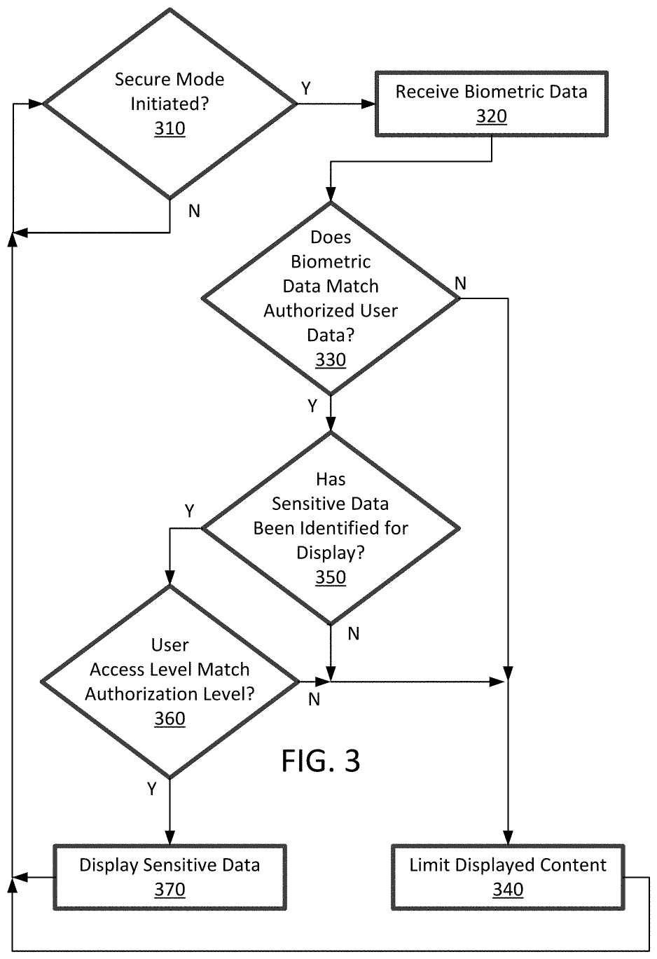

Methods consistent with the present disclosure do not require a computing device that can be physically separated from a head worn unit. In such instances, commercially available head worn computing devices similar to the Microsoft Hololens may be used to implement methods consistent with the present disclosure. A processor at a head worn computing device may perform steps consistent with the flow chart of FIG. 3. Methods consistent with the present disclosure also do not necessarily require a head worn device at all. In such instances, a display of a computing device may include a screen privacy polarizer that only allows users that are directly in front of the display to seen content displayed on a display. Methods consistent with the present disclosure may require that a user viewing sensitive information be directly in front of the display when sensitive data is displayed on the display. Secure data displayed on the display may also be displayed as a set of three dimensional (3D) images that require 3D glasses to clearly view the displayed data. In such instances two separate images may be displayed on the display, where a first lens of the 3D glasses allows a first image to pass while blocking a second image. A second lens of the 3D glasses may allow the second image to pass while blocking the first image. In instances when a head mounted unit is not used, the detection of eyes of other individuals or unauthorized individuals may cause display content to be changed or be removed from a display.

FIG. 3 illustrates a series of steps that may be performed when steps consistent with the present disclosure are implemented. The steps performed in FIG. 3 may be performed by the user device of FIG. 2. FIG. 3 begins with determination step 310 that identifies whether a secure mode at a computing device has been initiated, when no, program flow may stay at step 310. When the secure mode has been initiated, determination step 310 may move to step 320 where biometric data may be received. Next, determination step 330 may identify whether the received biometric data matches a set of authorized user data, when no, program flow may move to step 340 where content displayed on a display is limited or restricted. In one instance, content that is not classified as sensitive may be displayed on the display. This may help obfuscate that a computing device actually has the capability of selectively displaying material. Consider an instance when an operative of the Central Intelligence Agency (CIA) wishes to view top secret information, yet has been interrupted by a security agency of an adversary. If an agent of the adversary were to attempt to view content on the display, their biometric data would not match an authorized user and methods consistent with the present disclosure may allow the adverse agent to only see content that was not sensitive. For example, the adverse agent may be able to view a YouTube video, vacation photos, or public documents while being prevented from viewing or listening to sensitive content. In such instances, the adverse agent would not be aware of the fact that the computing device stored data that was inaccessible to them. Alternatively step 340 of FIG. 3 may limit displayed content by providing a blank screen.

In an instance when determination step 330 identifies that the biometric data does match an authorized user, program flow may move to step 350 that identifies whether a set of sensitive data has been identified for display. Sensitive data may be selected by the user interacting with a user interface or data entry device, or a user may identify a data selection by looking at a portion of the screen and blinking their eyes or by providing some other gesture. Eye tracking software and gesture sensor detecting software may cause a processor to identify that a user has made a selection by evaluating data received via one or more sensors communicatively coupled to the processor. In either instance an authorized user may make selections of content to be displayed when the user has an access level or security clearance level commensurate with viewing a type of secure data. In certain instances, a first user may be able to select content to view, yet not be allowed to view that content because their security clearance is not high enough. In such an instance the user may select content and then pass a head mounted unit to another person that does have a security clearance high enough to view the sensitive content. This capability would allow support personnel to prepare documents to be viewed by their superiors while not allowing those support personnel to view the sensitive content. When the user access level does not match the authorization level, program flow may move from step 360 to step 340 where content displayed on the display is limited. When determination step 360 identifies that a user access level matches an authorization level program flow may move from step 360 to step 370 where the sensitive data is displayed on the display. After step 370 or after step 340, program flow may move back to step 310 of FIG. 3. As such, the steps of FIG. 3 may be performed iteratively over time to guarantee that only authorized users can view the sensitive data.

Note that the user access levels may correspond to one or more security clearance levels of the United States government or other organization. As such, approved users may be assigned an access level of top secret, secret, classified, or be assigned to an administrative access level. Each of these levels may correspond to a set of authorization levels within which sensitive documents are classified. Users with top secret clearance level may be allowed to see all types of sensitive documents. Users with a secret clearance level may be able to see secret materials, classified materials, or materials associated with administrative functions. Users with a classified clearance level may be allowed to view classified documents or materials associated with administrative functions. Users with an administrative clearance level may be allowed to perform administrative functions while not being able to view or listen to content that is assigned a security clearance level that is above an administrative authorization level. Any particular user may, thus, be allowed to view content with clearance levels that match or that are below an access level assigned to that particular user.

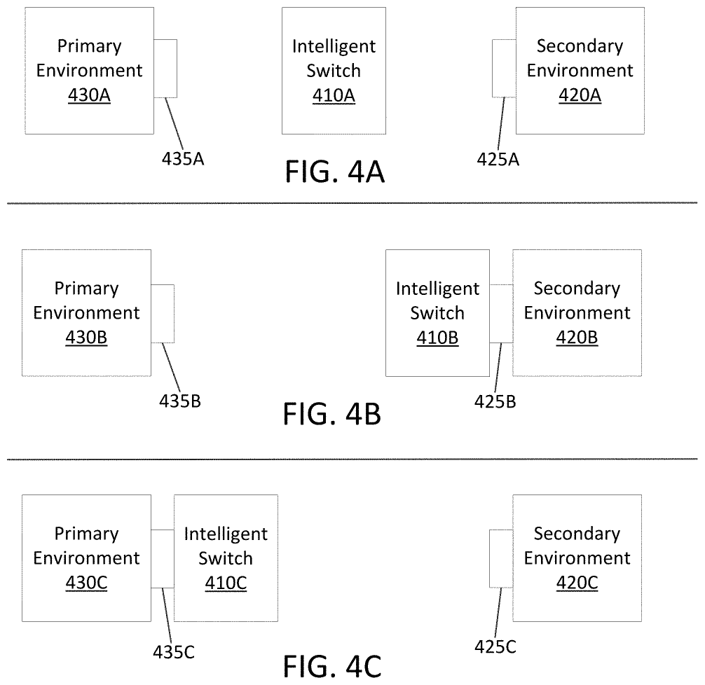

FIGS. 4A, 4B, and 4C conceptually illustrate different connection configurations consistent with the present disclosure. FIG. 4A illustrates a configuration where three different components of a system are communicatively disconnected/isolated from each other. The configuration of FIG. 4A may be referred to as a neutral configuration because intelligent switch 410A is not communicatively coupled to secondary environment 420A or to primary environment 430A. The system of FIGS. 4A, 4B, and 4C may be incorporated into a single computing device, where intelligent switch 410A, secondary environment 420A, and primary environment 430A may be contained within a single enclosure. Alternatively, intelligent switch 410A, secondary environment 420A, and primary environment 430A may be included in one or more separate devices.

FIG. 4A includes intelligent switch 410A, secondary environment 420A, interconnection 425A, primary environment 430A, and interconnection 425B. Note that switch 410A is communicatively disconnected from both secondary environment 420A and from primary environment 430A. In such a configuration, intelligent switch 410A may be separated from secondary environment 420A and primary environment 430A by an “air-gap.” Such air-gaps may prevent the intelligent switch from being physically electrically connected to secondary environment 420A or primary environment 430A. Physical interconnections 425A and 435A may allow intelligent switch 410A to be connected to secondary environment 420A or primary environment 430A by switches that form direct electrical connections where certain electrical conductors may form a communication pathway between intelligent switch 410A and secondary environment 420A, for example. These electrical conductors may be electrically connected by a switch that may include a transistor, field effect transistor (FET), a relay, or other switching device. Switches used to isolate one environment from another may alternatively be a manual switch that requires a user to activate the switch. Such physical switches may be any type of mechanical switch known in the art capable of switching electrical contacts from one configuration to another. Examples of such switches include, yet are not limited to a slide switch or magnetically actuated switches. All a user would have to do is move the switch or move a magnet close to a magnetic switch to change from using electronic components of the primary environment 430A to using electronic components of secondary environment 420A. Switches included in an apparatus consistent with the present disclosure may not be visible on an outer portion of the apparatus. For example, a switch may be hidden under a cover or case of the apparatus or a magnetic switch may be placed on an internal portion of the apparatus in a location where a magnet may be placed over the switch when a secure mode of operation is initiated.

In certain instances, these switches may connect a parallel communication bus or a serial communication connection. Parallel communication buses or serial communication connections may be implemented using any standard or non-standard communication bus known in the art. As such, parallel communications may be performed using any interface including, yet not limited to a local communication bus, a peripheral communication (PCI) bus, an Ethernet connection, a universal serial bus (USB), PCI express (PCIe), or other form of direct communication connection.

While methods and systems consistent with the present disclosure may use direct electrical interconnections, other embodiments may use wireless communication interfaces that may be turned off. In such instances, these wireless communication interfaces may be disabled by a switch, for example by a switch that turns off power to electronics associated with a wireless transmitter or receiver could disable reception or transmission of wireless signals. Alternatively a wireless transmission device or antenna may simply be switched out of a circuit when a communication pathway is disabled.

FIG. 4B illustrates an exemplary configuration consistent with the present disclosure. FIG. 4B includes intelligent switch 410B, secondary environment 420B, interconnection 425B, primary environment 430B, and interconnection 435B. FIG. 4B illustrates a configuration where intelligent switch 410B is communicatively coupled to secondary environment 420B and is not communicatively coupled to primary environment 430B. Communications between intelligent switch 410B and 420B may be initiated after secondary environment 420B has received data from an external computer or from a connectable memory device like a USB memory stick. In such an instance, secondary environment 420B and intelligent switch 410B may include a secondary communication mechanism (not illustrated) that may inform intelligent switch 410A that computer data has been received from an external computer. Alternatively, intelligent switch 410B may periodically connect with secondary environment 420B to check whether secondary environment 420B has received any new computer data that needs to be tested before it can be passed to primary environment 430B.

When intelligent switch 410B and secondary environment 420B are communicatively connected via interconnect 425B, intelligent switch 410B may receive the computer data from secondary environment 420B. After this point in time, intelligent switch 410B may test the received computer data to see if it contains undesired content. Intelligent switch 410B may perform tests that include pattern matching, whitelist/blacklist comparisons, and or other tests capable of detecting malware, viruses, or spam. Tests performed by Intelligent switch 410B may be performed in the neutral configuration illustrated in FIG. 4A or may be initiated with intelligent switch is receiving information from secondary environment 420B.

In an instance when the tests performed by an intelligent switch identify that computer data received from a secondary environment do not include undesired content, that switch may be communicatively coupled to a primary environment in a configuration illustrated in FIG. 4C, for example.

FIG. 4C illustrates a second exemplary configuration consistent with the present disclosure. FIG. 4C illustrates that intelligent switch 410C is communicatively coupled to primary environment 430C via interconnect 435C. FIG. 4 also illustrates that intelligent switch 410C and secondary environment 420C are not communicatively coupled via interconnect 425C. In the configuration of FIG. 4C, primary environment 430C may receive computer data only after intelligent switch 410C has tested received computer data and identified that the received computer data does not include undesired content. Functionality associated with intelligent switches may be fixed after intelligent an intelligent switch is fabricated. As such, the functionality of an intelligent switch may be programmed one (using a one-time programmable memory/read only memory), may be set using a mask read only memory (ROM), may be implemented by digital logic associated with a field programmable gate array (FPGA) coupled to a one-time only memory/ROM, or may be implemented by other forms of digital logic known in the art.

In an instance where an intelligent switch can sometimes receive communications from a secondary environment via a secondary communication mechanism, that secondary communication mechanism may be disabled (e.g. switched out of the circuit or turned off) when the intelligent switch is communicatively coupled to the primary environment such as the configuration shown in FIG. 4C.

While FIG. 4 illustrates three different environments that include primary environment 430A-B-C, intelligent switch 410A-B-C, and secondary environment 420A-B-C, apparatus consistent with the present disclosure are not required to include three different environments. In certain instances, apparatus consistent with the present disclosure may include two different computing environments. Such an apparatus may include a first environment that may not include an ability to decrypt or display sensitive content and a second environment that may be able to decrypt or display the sensitive content.

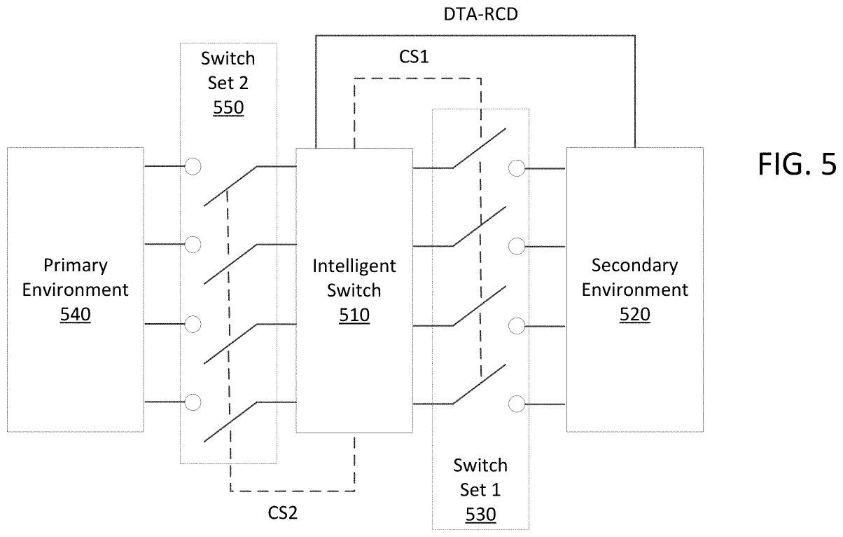

FIG. 5 illustrates exemplary switches that may be used to connect an intelligent switch to either a secondary environment or a primary environment. FIG. 5 includes intelligent switch 510, secondary environment 520, switch set 1 530, primary environment 540, and switch set 2 550. The opening and closing of switches included in switch set 1 530 may be controlled by control signal CS1 and the opening and closing of switches included in switch set 2 550 may be controlled by control signal CS2. Although not illustrated in FIG. 5, secondary environment 520 may include a network interface (wired or wireless) that may receive or send computer data respectively from or to other computing devices.

Control signal CS1 may be used to close the switches of switch set 1 530 to communicatively connect the intelligent switch 510 to the secondary environment 520. Control signal CS2 may be used to close the switches of switch set 2 550 to connect the intelligent switch 510 to primary environment 540. Control signal CS1 may be used to connect the intelligent switch 510 to the secondary environment 520 after data control signal DTA-RCD informs the intelligent switch that computer data has been received by secondary environment 520. Once the switches of switch set 1 530 are closed, communication connections are made such that secondary environment 520 may provide received computer data to intelligent switch 510. At this time primary environment 540 may be protected from hacking, screen-scraping, or key-logging because it is physically isolated from the secondary computing environment and from any external communication path.

After intelligent switch 510 receives the computer data from secondary environment 520, intelligent switch 510 may open the switches of switch set 1 530 and may test the received computer data for undesired content. When intelligent switch 510 identifies that the received computer data does not include undesired content, it may close the switches of switch set 2 550 using control signal CS2. After the switches of switch set 2 550 are closed, intelligent switch 510 may provide the received computer data to primary environment 540. Preferably, switches associated with switch set 1 530 and switch set 2 550 will never be closed at the same time.

In certain instances, logic or processors at a secondary environment may perform a first set of initial tests on received computer data. The secondary environment may be configured to only transmit computer data to an intelligent switch only after this first set of initial test pass. Intelligent switches 510, the secondary environment 520, or the primary environment 540 may include logic or processors that may perform functions consistent with the present disclosure. Intelligent switch may be implemented using a set of field effect transistors (FETs) or bipolar transistors.

Various environments consistent with the present disclosure may include different forms of functionality. For example, secondary environments discussed in respect to FIGS. 4-5 may include operating system (OS) software (e.g. Android™ compatible OS software), application programs, and one or more data sources (vectors). Such data sources/vectors may include a communication interface wired or wireless, a universal serial bus (USB) port wireless or physical, another secure digital (SD) card, sensors, or other interfaces. A primary environment may include a JAVA OS, a user interface, and user data storage, for example.

Primary environments and secondary environments consistent with the present disclosure may never be physically connected together at any time. A user associated with the primary environment may communicate securely with a second user device operated by a second user. After a message is received in the secondary environment from the second user device, an intelligent switch may be communicatively coupled to the secondary environment after which content included in the received message may be tested an provided to the primary environment securely according to the switching configurations and testing discussed in respect to FIGS. 4-5.

The functionality of a secondary environment and an intelligent switch may be combined, when desired. In such instances, a switch set may isolate functions of an intelligent switch from the secondary environment via switches. While the ability to isolate an intelligent switch from a secondary environment and from a primary environment may be preferred, alternative embodiments may couple the secondary environment to the intelligent switch without switches. This may include coupling the secondary environment to the intelligent switch via a proprietary communication interface or by using a proprietary communication technique. In such instances, the primary environment may only receive computer data after it has been tested and after a connection has been formed via operation of the intelligent switch that allows the primary environment to receive the tested computer data.

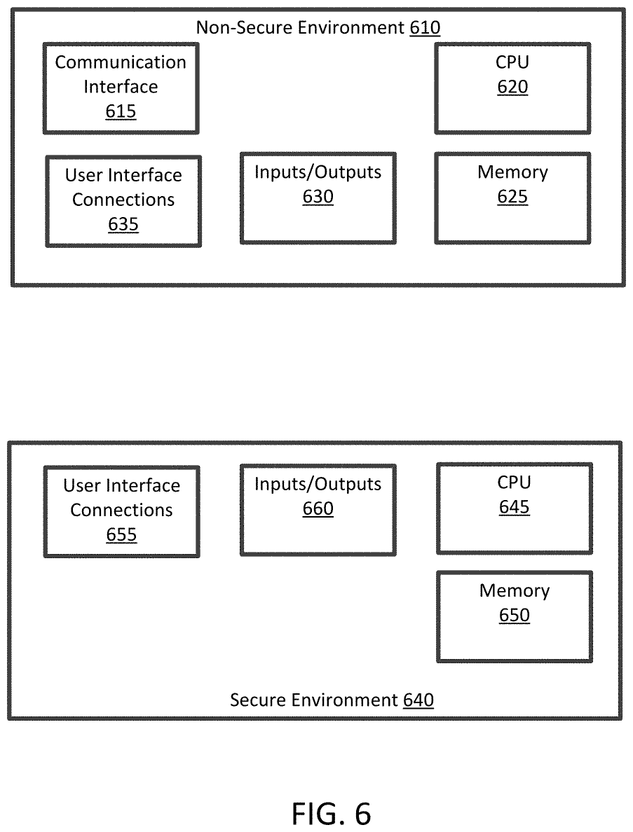

FIG. 6 illustrates components that maybe included in a non-secure (not isolated) environment and in a secure (isolated) environment. Non-secure environment 610 of FIG. 6 includes communication interface 615, CPU (or processor) 620, memory 625, inputs/outputs 630, and user interface connection 635. Secure environment 640 includes CPU (or processor) 645, memory 650, user interface connections 655, and input/outputs 660. Note that communication interface 615 may allow non-secure environment 610 to receive communications from external computing devices. As such communication interface 615 may allow computing devices consistent with the present disclosure to receive or to provide data to a computer via the Internet or other communication network. CPU 620 may execute instructions out of memory 625 when computer data is received or when evaluations are performed on received computer data. Inputs/outputs 630 may allow non-secure environment 610 to send or receive information from secure environment 640. In certain instances information may be transmitted through other devices associated with intelligent switch 410A of FIG. 4A. This may allow a processor that is not part of either non-secure environment 610 or secure environment 640 to analyze received computer data for the presence of malware when each of the non-secure environment 610 or the secure environment 640 are disconnected from an isolated processor. User interface connections may allow CPU 620 of non-secure environment 610 to control content displayed on a display or to control content that is provided to a speaker or headphone when a non-secure mode of operation is active. CPU 645 may receive information from non-secure environment 610 or from another processor via inputs/outputs 660. CPU 645 may execute instructions out of memory 650 when preparing to provide data for display on a display or when providing data to a speaker. User interface connection 655 may allow CPU 645 to provide information to the display or speaker, after a secure mode of operation has been initiated.

CPU 620 of non-secure environment 610 and CPU 645 of secure environment 640 may be processors of different types, may be processors that execute program instructions associated with different types of operating systems, or may be processors of different types that also execute different types of operating system program code. As such, CPU 620 could be an ARM processor and CPU 645 could be an Intel compatible processor. As such, the ARM processor could execute program code associated with a first type of software that is ARM compatible and the Intel compatible processor could execute program code consistent with the Microsoft Windows operating system, for example. Different types of processors and different types of program code operating in respective different environments should make computing devices consistent with the present disclosure less likely to be exploited by a set of malware. Even if malware were able to affect one environment, it would likely not be able to affect both environments.

Here again switches may be used to switch between different operating environments. Depending on a switching position, switches discussed in respect to FIGS. 3-4 may cause CPU 645 to initiate the execution of program code instructions consistent with operation of secure environment 645 or may disable the execution of instructions by CPU 645. When these switches are in a first position, operations consistent with non-secure environment 610 may be performed and user interface connections 635 may be connected to a display of a user device. When the switches are in a second position, operations consistent with secure environment 640 may be performed or initiated and user interface connections 655 may be connected to the display of the user device. Other user interface connections that may be switched may include connections to a speaker or to a microphone. Software executed by CPU 640 out of memory 650 may cause displayed content to change according to the steps described in respect to FIG. 3.

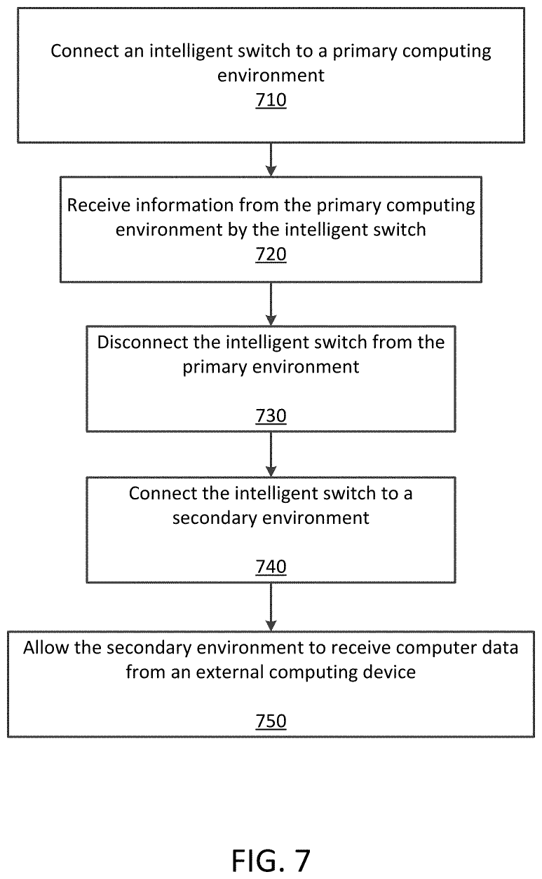

FIG. 7 illustrates an exemplary flow of actions consistent with the present disclosure that may be performed when a user wishes to access content from a remote computing device. In such an instance access requests from the primary environment may be passed to an intelligent switch, such that the intelligent switch may cause a processor associated with the secondary environment to access a website at the Internet, for example. Step 710 of FIG. 7 is where an intelligent switch switches from a neutral position where it may not be communicatively coupled to any other environment to being communicatively coupled to a primary computing environment. This communicative coupling may be implemented by switching one or more switches that make physical electrical interconnections or that enable or disable the coupling of data. Alternatively, communications between the primary environment and the intelligent switch may be performed via wireless communications. The enabling of communications between the primary environment and the intelligent switch may be performed periodically or may be performed based on a communication sent by a secondary means from the primary environment to the intelligent switch. Here again a secondary communication means may include a single communication signal that switches state.

After the intelligent switch connects the primary environment to the intelligent switch in step 710, information from the primary environment may be received by the intelligent switch at step 720 of FIG. 7. The information received from the primary environment may be a request to access information at a server or website. Such a request could include or be related to accessing information associated with a universal resource locator (URL), for example. The intelligent switch may then disconnect from the primary environment in step 730 and then connect to the secondary environment in step 740 of FIG. 7.

After step 740, the secondary environment may be allowed to access data from an external computing device. For example, a URL provided with a request received from the primary environment in step 720 may be accessed by the secondary environment. As such, intelligent switches consistent with the present disclosure may selectively connect to either a primary or to a secondary computing environment based on a protocol that may include periodic switching, secondary communications, or proprietary communications that can cause the primary computing environment to always be disconnected/isolated from the secondary computing environment. By doing this, methods and apparatus consistent with present disclosure constitute a new form of “air-gapping” of specific parts of an overall computing system when performing a security function.

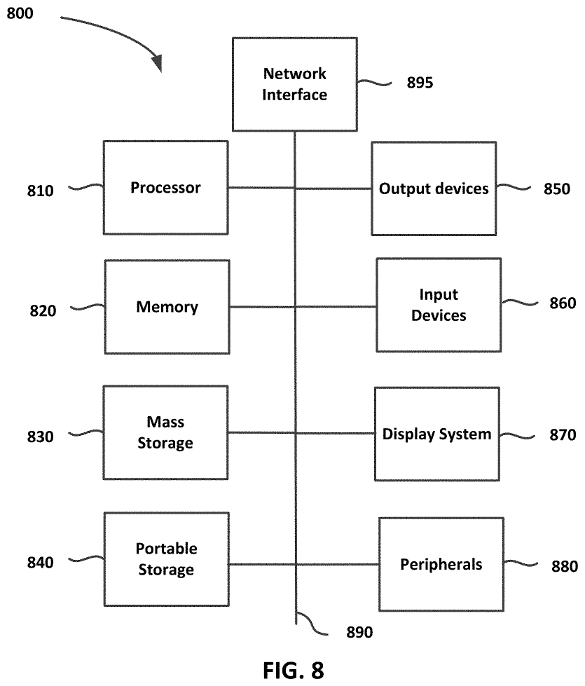

FIG. 8 illustrates a computing system that may be used to implement an embodiment of the present invention. The computing system 800 of FIG. 8 includes one or more processors 810 and main memory 820. Main memory 820 stores, in part, instructions and data for execution by processor 810. Main memory 820 can store the executable code when in operation. The system 800 of FIG. 8 further includes a mass storage device 830, portable storage medium drive(s) 840, output devices 850, user input devices 860, a graphics display 870, peripheral devices 880, and network interface 895.

The components shown in FIG. 8 are depicted as being connected via a single bus 890. However, the components may be connected through one or more data transport means. For example, processor unit 810 and main memory 820 may be connected via a local microprocessor bus, and the mass storage device 830, peripheral device(s) 880, portable storage device 840, and display system 870 may be connected via one or more input/output (I/O) buses.

Mass storage device 830, which may be implemented with a magnetic disk drive or an optical disk drive, is a non-volatile storage device for storing data and instructions for use by processor unit 810. Mass storage device 830 can store the system software for implementing embodiments of the present invention for purposes of loading that software into main memory 820.

Portable storage device 840 operates in conjunction with a portable non-volatile storage medium, such as a FLASH memory, compact disk or Digital video disc, to input and output data and code to and from the computer system 800 of FIG. 8. The system software for implementing embodiments of the present invention may be stored on such a portable medium and input to the computer system 800 via the portable storage device 840.

Input devices 860 provide a portion of a user interface. Input devices 860 may include an alpha-numeric keypad, such as a keyboard, for inputting alpha-numeric and other information, or a pointing device, such as a mouse, a trackball, stylus, or cursor direction keys. Additionally, the system 800 as shown in FIG. 8 includes output devices 850. Examples of suitable output devices include speakers, printers, network interfaces, and monitors.

Display system 870 may include a liquid crystal display (LCD), a plasma display, an organic light-emitting diode (OLED) display, an electronic ink display, a projector-based display, a holographic display, or another suitable display device. Display system 870 receives textual and graphical information, and processes the information for output to the display device. The display system 870 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 880 may include any type of computer support device to add additional functionality to the computer system. For example, peripheral device(s) 880 may include a modem or a router.

Network interface 895 may include any form of computer interface of a computer, whether that be a wired network or a wireless interface. As such, network interface 895 may be an Ethernet network interface, a BlueTooth™ wireless interface, an 802.11 interface, or a cellular phone interface.

The components contained in the computer system 800 of FIG. 8 are those typically found in computer systems that may be suitable for use with embodiments of the present invention and are intended to represent a broad category of such computer components that are well known in the art. Thus, the computer system 800 of FIG. 8 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer can also include different bus configurations, networked platforms, multi-processor platforms, etc. The computer system 700 may in some cases be a virtual computer system executed by another computer system. Various operating systems can be used including Unix, Linux, Windows, Macintosh OS, Palm OS, Android, iOS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, FLASH memory, a flexible disk, a hard disk, magnetic tape, any other magnetic medium, a CD-ROM disk, digital video disk (DVD), any other optical medium, RAM, PROM, EPROM, a FLASH EPROM, and any other memory chip or cartridge.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASH EPROM, and any other memory chip or cartridge.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed is:

1. A method for protecting sensitive data, the method comprising:
identifying that a position of a switch at a computing device corresponds to a first position of the switch;
initiating operation of a secure operating mode at the computing device after identifying that the position of the switch at the computing device corresponds to the first position, the secure operating mode controlling when the sensitive data can be displayed on the display;
receiving biometric data of a person focusing an eye on a display;
identifying that the biometric data of the person focusing the eye on the display matches biometric data of an authorized user; and
displaying the sensitive data on the display based on the initiation of the secure operating mode at the computing device and the identification that the biometric data of the person focusing the eye on the display matches the authorized user.

2. The method of claim 1, further comprising:
identifying that the sensitive data corresponds to a first type of data of one or more data types;
comparing privileges of the authorized user with a user profile that cross-references the one or more data types with a user access level of one or more user access levels; and
identifying that the authorized user is allowed to view the first type of data based on the user access level corresponding to the privileges of the authorized user.

3. The method of claim 1, further comprising:
receiving the sensitive data at a first processor at the computing device; and
performing an analysis on the sensitive data that identifies that the sensitive data does not include malware.

4. The method of claim 1, wherein the secure operating mode at the computing device is initiated after the switch at the computing device has been switched from a second position to the first position and a processor at the computing device executes instructions not associated with the secure operating mode when the switch is at the second position.

5. The method of claim 1, further comprising:
receiving an indication that the person is wearing a head mounting unit that includes the computing device; and
collecting the personal biometric data based on the received indication.

6. The method of claim 1, further comprising identifying that the computing device has been attached to a head mounting unit, wherein the head mounting unit receives the computing device and attaches to a head of the person.

7. The method of claim 1, further comprising:
identifying that the authorized user has stopped focusing the eye on the display; and
removing the sensitive data from being displayed on the display based on the identification that the authorized user has stopped focusing the eye on the display.

8. The method of claim 1, further comprising:
identifying that an individual is currently wearing a display unit that includes the computing device;
receiving biometric data of an individual wearing the display unit;
identifying that the biometric data of the individual wearing the display unit matches biometric data of a second authorized user; and
displaying the sensitive data on a display based on the initiation of the secure viewing capabilities at the computing device and the identification that the biometric data of the individual wearing the display unit matches the second authorized user.

9. The method of claim 7, further comprising displaying other data on the display after the sensitive data has been removed from the display.

10. The method of claim 1, further comprising:
receiving information from a user interface at the computing device;
identifying that the received information does not match information associated with a user that is allowed to view the sensitive data; and
displaying other information on the display based on the received information not matching the information associated with the allowed user.

11. The method of claim 1, wherein the eye of the person is contained within a viewing shade that fits over a portion of a face of the person.

12. A non-transitory computer-readable storage medium having embodied thereon a program executable by a processor for protecting sensitive data, the method comprising:
identifying that a position of a switch at a computing device corresponds to a first position of the switch;
initiating operation of a secure operating mode at the computing device after identifying that the position of the switch at the computing device corresponds to the first position, the secure operating mode controlling when the sensitive data can be displayed on the display;
receiving biometric data of a person focusing an eye on a display;
identifying that the biometric data of the person focusing the eye on the display matches biometric data of an authorized user; and
displaying the sensitive data on the display based on the initiation of the secure operating mode at the computing device and the identification that the biometric data of the person focusing the eye on the display matches the authorized user.

13. The non-transitory computer-readable storage medium of claim 12, the program further executable to:
identify that the sensitive data corresponds to a first type of data of one or more data types;
compare privileges of the authorized user with a user profile that cross-references one or more data types with a user access level of one or more user access levels; and
identify that the authorized user is allowed to view the first type of data based on the user access level corresponding to the privileges of the authorized user.

14. The non-transitory computer-readable storage medium of claim 12, the program further executable to:
receive the sensitive data at a first processor at the computing device; and
perform an analysis on the sensitive data that identifies that the sensitive data does not include malware.

15. The non-transitory computer-readable storage medium of claim 12, wherein the secure operating mode at the computing device is initiated after the switch at the computing device has been switched from a second position to the first position and a processor at the computing device executes instructions not associated with the secure operating mode when the switch is at the second position.

16. The non-transitory computer-readable storage medium of claim 12, the program further executable to:
receive an indication that the person is wearing a head mounting unit that includes the computing device; and
collect the personal biometric data based on the received indication.

17. An apparatus for protecting sensitive data, the apparatus comprising:
a display;
a sensor that senses biometric data;
a switch;
a first memory;
a first processor that executes instructions out of the first memory to:
identify that a position of the switch corresponds to a first position of the switch,
initiate operation of a secure operating mode after identifying that the position of the switch corresponds to the first position, the secure operating mode controlling when the sensitive data can be displayed on the display
receive biometric data of a person focusing an eye on the display from the sensor,
identify that the biometric data of the person focusing the eye on the display matches biometric data of an authorized user, and
control the display of the sensitive data on the display based on the initiation of the secure operating mode at the computing device and the identification that the biometric data of the person focusing the eye on the display matches the authorized user.

18. The apparatus of claim 17, further comprising instructions executable by the first processor that cross-references the sensitive data to one or more data types, wherein the first processor executes the cross-referencing instructions to:
identify that the sensitive data corresponds to a first type of data of the one or more data types,
compare privileges of the authorized user with a user profile that cross-references the one or more data types with a user access level of one or more user access levels, and
identify that the authorized user is allowed to view the first type of data based on the user access level corresponding to the privileges of the authorized user.

19. The apparatus of claim 17, further comprising the switch, wherein the secure operating mode at the computing device is initiated after the switch at the computing device has been switched from a second position to the first position

20. The apparatus of claim 19, further comprising a second memory and a second processor that executes instructions out of the second memory that are not associated with the secure operating mode when the switch is at the second position.
